(19) United States
(12) Patent Application Publication
(10) Pub. No.: US 2026/0308009 A1
(43) Pub. Date: Oct. 8, 2026

(54) LLZO POWDER HAVING HIGH PHASE PURITY AND PROCESSES FOR SYNTHESIZING SAME

(71) Applicant: MATERION CORPORATION, Mayfield Heights, OH (US)

(72) Inventors: Brendan J. LIDDLE, Mayfield Heights, OH (US); Benjamin Thomas MOSHER, Mayfield Heights, OH (US)

(73) Assignee: MATERION CORPORATION, Mayfield Heights, OH (US)

(21) Appl. No.: 19/480,567

(22) PCT Filed: May 3, 2024
(86) PCT No.: PCT/US2024/027656

§ 371 Date: Oct. 31, 2025

Related U.S. Application Data
(60) Provisional application No. 63/499,789, filed on May 3, 2023.

(51) Int. Cl. C01G 25/00; H01M 10/0562

(52) U.S. Cl. CPC C01G 25/006; H01M 10/0562; C01P 2002/72; C01P 2006/40; C01P 2006/80; H01M 2300/0077

(57) ABSTRACT

A process of synthesizing a lithium lanthanum zirconium oxide (LLZO) powder may include mixing a lithium salt, water, and a precursor blend comprising a lanthanum precursor and a zirconium precursor to form a mixture. The process may include heating the mixture at low pressure to form a dried lithiated powder. The process may include calcining the dried lithiated powder to form a lithium lanthanum zirconium oxide powder. The LLZO powder may include a cubic garnet phase purity of greater than 95 wt %.

### PRIORITY CLAIM

The present application claims priority to U.S. Provisional Application No. 63/499,789, filed on May 3, 2023, the entire contents and disclosure of which is hereby incorporated by reference.

### FIELD

The present disclosure relates to the synthesis of Li₇La₃Zr₂O₁₂ (LLZO) and related powders, and processing methods using a lithium salt solution for providing LLZO powders having high phase purity.

### BACKGROUND

Lithium lanthanum zirconium oxide Li₇La₃Zr₂O₁₂ (LLZO) is a lithium-stuffed garnet material useful as a solid-state electrolyte material in battery technology applications. LLZO is useful as it provides high ionic conductivity at room temperature, low activation energy, good chemical and electrochemical stability, and wide potential window.

Conventional methods of making LLZO include solid-state synthesis of powder by mixing source oxides with a lithium source, among others as example routes. Some synthesis methods include lithium carbonate as lithium source. Using lithium carbonate as lithium source requires firing at high temperatures, e.g., greater than 723° C., to effect a transformation to the cubic garnet crystal structure and the reaction pathway can lead to the formation of impurity phases rather than the desired cubic garnet LLZO. These impurity phases may include tetragonal garnet, LiAlO₂, Li₂ZrO₃, and LaAlO₃ as well as others. The presence of impurity phases is undesirable as causes a reduction in the ionic conductivity of the resultant material in addition to causing ceramic processing defects.

Alternatively, lithium hydroxide can be used as lithium source. These processes involve first milling together, for example, LiOH, La₂O₃, ZrO₂, and Al₂O₃ powders. However, even when avoiding using lithium carbonate as lithium source in favor of non-carbonate lithium source material, the resulting mixture produced by the aforementioned techniques may form impurities, e.g., lithium carbonate, during processing steps prior to calcining. The resulting impurity levels may render the powder unsuitable for some applications.

Previous synthesis routes may have required a solvent, e.g., isopropanol, during milling or other processing steps. Solvents such as isopropanol are flammable and expensive. Manufacturing with safer solvents satisfies a long-felt need in the synthesis of powders as disclosed herein.

Thus, the need exists for an uncomplicated, solid state powder synthesis process to provide high cubic garnet structure phase purity LLZO, while also providing process improvements such as using process-friendly solvents, drying techniques, and/or lower calcining temperatures than conventional solid state synthesis processes for making lithium lanthanum zirconium oxide powders.

### SUMMARY

In some aspects, the techniques described herein relate to a process of synthesizing a lithium lanthanum zirconium oxide powder. The process includes mixing a lithium salt, water, and a precursor blend comprising a lanthanum precursor and a zirconium precursor to form a mixture. The lithium salt may have a melting point of less than 605° C. The lithium salt does not comprise lithium acetate. The process also includes heating the mixture at low pressure to form a dried lithiated powder. The process further includes calcining the dried lithiated powder to form the lithium lanthanum zirconium oxide powder. The lithium lanthanum zirconium oxide powder, which may include dopant(s), may have a cubic garnet phase purity of greater than 95 wt %. Heating the mixture at low pressure may include heating to a temperature from 85° C. to 135° C. at a pressure of from 51 kPa to 101 kPa.

In some aspects, the techniques described herein relate to a lithium lanthanum zirconium oxide composition having a cubic garnet phase purity of greater than 95 wt %.

### BRIEF DESCRIPTION OF THE DRAWINGS

A further understanding of the nature and advantages of the disclosed technology may be realized by reference to the remaining portions of the specification and the drawings.

FIG. 1 is a flow chart of an exemplary process.

FIG. 2 is a flow chart of exemplary processes.

FIG. 3 is a flow chart of an exemplary process.

FIG. 4 is an x-ray diffraction plot according to an exemplary process as in FIG. 3 lithiated with LiOH—H₂O.

FIG. 5 is an x-ray diffraction plot according to a comparative example.

FIG. 6 is an x-ray diffraction plot according to an exemplary process as in FIG. 3 lithiated with LiNO₃.

### DETAILED DESCRIPTION

### Introduction

As discussed above, LLZO powders produced using previous processes do not meet the demands for cubic garnet phase purity and processability. Specifically, previous solid state methods of making LLZO powders may lack the cubic garnet phase purity required for battery applications. Further, previous methods require calcinations for longer times and/or at higher temperatures, therefore lacking process efficiencies, e.g., product yields are low. This is due at least in part to impurities present and/or forming during processing as well as incomplete solid state reactions. Previous solid state methods of making LLZO powders also detrimentally require higher calcining temperatures, e.g., above 1100° C., or above 1200° C., to achieve crystallographic structure phase transformation.

Further, even when using a non-carbonate lithium source material, the resulting mixture produced by the aforementioned techniques may form impurity phases such as tetragonal garnet despite the presence of dopants (e.g., Al⁺³ or Ga⁺³) which are intended to substitute at crystallographic Li⁺ sites to stabilize the cubic structure. These tetragonal impurities have significantly lower Li ion conductivity making it unsuitable for some applications.

It has now been discovered that the disclosed processes prevent unwanted sources of impurities, thereby promoting more efficient transformation to the LLZO cubic garnet phase during calcination, to yield high phase purity. The minimization or elimination of carbonate formation by providing the lithium source in solution, e.g., to impregnate lanthanum and zirconium precursors, optionally employed in combination with low pressure drying techniques, synergistically provide consistently high phase purity LLZO while advantageously simplifying the process. Process advantages include lowering the calcining temperature and excluding undesirable solvents, e.g., isopropanol, from the process. The process improvements herein contribute by limiting mixing times with the lithium source, thus lessening the chance of carbonate formation.

It has also found that the melting point of the lithium salt used for lithiation in processes herein is important. Unexpectedly, it was found that lithium salts having high melting points, e.g., greater than 605° C. do not perform to produce the desired transformation to cubic garnet phase, as compared with lower melting point lithium salts. This is believed due to the lower melting point lithium salts having ready availability of lithium ions to form intermediate phases promoting the subsequent transformation to cubic garnet crystal structure. Also, unexpectedly, the chemical structure of lithium acetate as compared to other low melting point lithium salts, yields little or no cubic garnet phase upon calcination according to processes herein. Other low melting point lithium salts, surprisingly, performed much better.

To achieve high phase purity while also effecting process improvements, the inventors have now found that providing a lithium salt in solution, e.g., during process step(s) to impregnate a precursor blend of lanthanum and zirconium, and optionally dopant(s), preceding calcining, reduces and/or eliminates the presence of carbonates. This beneficially leads to higher cubic garnet phase purity of the resultant LLZO powder after calcining. In contrast, conventional processes, wherein lithium, lanthanum, and zirconium sources are co-mixed provide powders that suffer from the problem of high impurity phase content. The inventors have found that when mixing in the presence of a soluble lithium source is limited during processing, and by providing the lithium source as a lithium hydroxide solution, then the powder impurities are advantageously reduced. The inventors have found that this can be accomplished by providing an (already thoroughly) mixed precursor blend (comprising precursors of greater than lanthanum and zirconium) to mix with a lithium hydroxide solution. Further, these processes can be used in combination with the subsequent forming, e.g., by spray drying, of agglomerates to enhance transformation to the desired cubic garnet LLZO or by low pressure drying of the lithiated precursor blend prior to calcining.

The disclosed processes provide LLZO that is suitable for a wide variety of applications including for solid state lithium batteries as well as other advanced battery technologies.

### LLZO Powder Synthesis Process

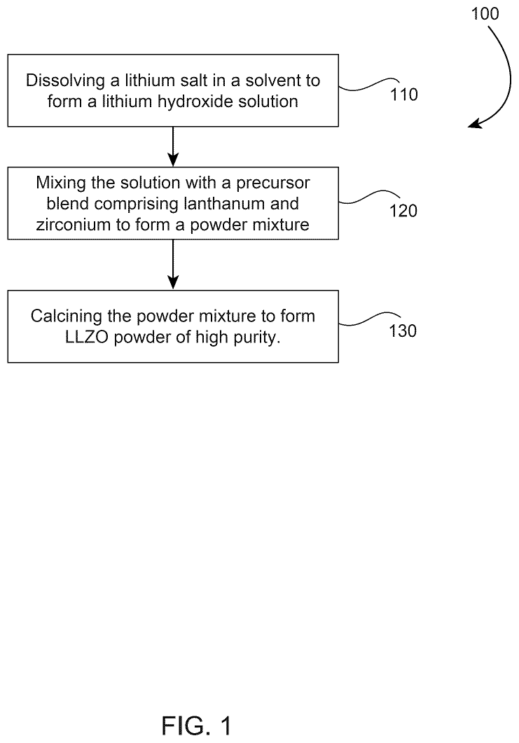

The disclosure relates to processes for synthesizing a LLZO powder that has the aforementioned advantages. An example process is illustrated in FIG. 1. The process comprises the step of dissolving a lithium salt in a solvent to form a lithium hydroxide solution. The process further includes mixing the solution with a precursor blend to form a powder mixture. The precursor blend comprises oxides and/or oxide precursors of lanthanum, zirconium, aluminum, tantalum, niobium, gallium, and/or indium. The powder mixture is then further processed as disclosed herein and calcined at a temperature ranging from 900° C. to 1100° C. to form the lithium lanthanum zirconium oxide powder. The resultant lithium lanthanum zirconium oxide can be a doped lithium lanthanum zirconium oxide, e.g., doped with Al³⁺, Ta⁵⁺, Nb⁵⁺, Ga³⁺, In³⁺, or combinations thereof, according to the initial precursor blend used in the process. Each of these steps are discussed in more detail below.

As noted above, the use of the aforementioned process, e.g., providing a lithium salt in solution during process step(s) to impregnate a precursor blend of lanthanum and zirconium, and optionally dopant(s), preceding calcining reduces and/or eliminates the presence of carbonates, thus providing for the aforementioned surprising results.

### Lithium Hydroxide and Lithium Hydroxide Solution

FIG. 1 illustrates process 100 herein for providing high purity LLZO powder. The process includes forming 110 a lithium hydroxide solution. Forming the solution is then followed by mixing 120 with a precursor blend comprising a lanthanum precursor and a zirconium precursor to form a powder mixture. The process further includes calcining 130 the powder mixture to form LLZO powder of high purity.

To form the lithium hydroxide solution, an initial lithium source, e.g., a lithium salt, may be dissolved in a solvent. The lithium salt can comprise lithium citrate (Li₃C₆H₅O₇), lithium hydroxide (LiOH), lithium nitrate (LiNO₃), or hydrates or other forms thereof, or combinations thereof. The lithium salt may be a powder. Preferably the lithium salt is soluble, e.g., soluble in water.

In embodiments herein, the lithium salt is preferably lithium citrate, lithium hydroxide, lithium nitrate, or hydrates or other forms thereof, or combinations thereof. The lithium salt may consist of lithium citrate, lithium hydroxide, lithium nitrate, or hydrates or other forms thereof, or combinations thereof. In certain embodiments herein, the lithium salt is lithium hydroxide, lithium nitrate, or hydrates or other forms thereof, or combinations thereof. The lithium salt may consist of lithium hydroxide, lithium nitrate, or hydrates or other forms thereof, or combinations thereof.

In some embodiments, the group of lithium salts excludes lithium acetate (LiCH₃CO₂), e.g., the lithium salt does not comprise lithium acetate. It is theorized that unsuitable lithium salts may include those that decompose at low temperatures and/or have lithium carbonate (Li₂CO₃) decomposition products, e.g., lithium formate (CHLiO₂) and lithium oxalate (LiC₂O₄), and lithium tartrate (C₄H₆Li₂O₇). Other lithium salts that are unsuitable include those having a higher melting point, e.g., 605° C. or higher such as lithium chloride (LiCl) having melting point of 605° C.; lithium sulfate (Li₂SO₄) having melting point of 859° C.; lithium carbonate (Li₂CO₃) having melting point of 723° C., and lithium phosphate (Li₃PO₄) having melting point of 837° C. Lithium hydride is also unsuitable because lithium hydride reacts immediately with water to make H₂ gas and LiOH. The heat of reaction tends to ignite the H₂ generated and make a flame.

In some embodiments, the group of lithium salts excludes lithium acetate, lithium carbonate, lithium formate, lithium oxalate, and lithium tartrate. In some embodiments, the group of lithium salts excludes lithium chloride, lithium sulfate, lithium carbonate, and lithium phosphate. In some embodiments, the group of lithium salts excludes lithium hydride. In some embodiments, the group of lithium salts excludes lithium acetate, lithium carbonate, lithium formate, lithium oxalate, lithium tartrate, lithium chloride, lithium sulfate, lithium carbonate, lithium phosphate, and lithium hydride.

In some embodiments, the lithium source is hydrous or anhydrous lithium hydroxide: LiOH (H₂O)ₙ. For example, the lithium source may comprise lithium hydroxide (LiOH) (or “anhydrous lithium hydroxide”) and/or lithium hydroxide monohydrate (LiOH·H₂O). In certain embodiments, the lithium source is a lithium hydroxide powder.

In some cases, the lithium source powder is also high purity. For example, the initial powder(s) of lithium hydroxide and/or lithium hydroxide monohydrate may have a purity greater than (and including) 2N (99%), e.g., 3N (99.9%), 3N5 (99.95%), or 4N (99.99%). In some embodiments, the lithium source powder has a purity of 3N. In some cases, the lithium source powder has a purity greater than (and including) 3N or greater than (and including) 3N5.

The lithium source powder(s) may have an average particle size up to 1.0 mm. The lithium source powder(s) may have an average particle size ranging from 0.001 μm to 1000 μm, e.g., from 0.01 μm to 1000 μm, from 0.1 μm to 500 μm, or from 1.0 μm to 100 μm. In terms of lower limits, the average particle size of the lithium source powder may be greater than 0.001 μm, e.g., greater than 0.01 μm, greater than 0.1 μm, or greater than 1.0 μm. In terms of upper limits, the average particle size of the lithium source powder may be less than 1000 μm, e.g., less than 500 μm, less than 100 μm, less than 50 μm, or less than 10 μm.

Suitable lithium source powders are commercially available, e.g., lithium hydroxide (via Albemarle) and/or lithium hydroxide monohydrate (via Albemarle or Livent).

In certain aspects, process 100 includes dissolving a lithium salt in a solvent to form a lithium hydroxide solution. The solvent may comprise water, ethanol, isopropanol, or methanol, or combinations thereof. Preferably, the solvent is water.

In some cases, the lithium hydroxide may be dissolved in water. The water may be characterized as de-gassed and/or deionized water.

The solubility limit for lithium hydroxide in water at 20° C. is 12.8 g/100 ml, or a concentration of 12.8%. In an example, a lithium hydroxide solution suitable for mixing with the precursor blend described in processes herein comprises 60 wt % LiOH and 40 wt % water for mixing with the precursor blend. Embodiments herein comprise a lithium hydroxide solution having less than 60 wt % solvent based upon total weight of the lithium hydroxide solution, (e.g., less than 50 wt % solvent, less than 45 wt % solvent, or less than 40 wt % solvent). In a particular embodiment, a lithium hydroxide solution comprising 60 wt % LiOH and 40 wt % water is mixed with the precursor blend.

In some embodiments, lithium hydroxide solutions herein can be characterized as having a molarity in a range from 1 M to 5.3M. Other molarities are contemplated, however for processability it is noted that a more dilute solution is not desirable. This is because the more solvent (e.g., water) for preparing the solution means the more solvent to then be removed, which requires more energy. Solution stirring times may vary due to scale of operation and/or lithium source and/or solvent used. For example, solution stirring times may range from just minutes to several hours, preferably from 5 minutes to one hour. Solution stirring time vary according to solvent used, e.g., dissolving lithium hydroxide in alcohol solvents (such as methanol and ethanol) requires longer stirring time to solution than for water. Advantageously, water is the preferred solvent used herein and lithium hydroxide is more soluble in water than the aforementioned alcohol solvents.

In aspects herein, the process excludes solvents other than water. As those of skill in the art appreciate, not using flammable liquids, e.g., isopropanol, ensures a safer process while also yielding economic advantages (lower cost).

In an example process as described herein using LiOH as the lithium salt results in a lithium hydroxide solution having a concentration of 11.6% based on maximum solubility.

### Precursor Blend

The precursor blend for mixing, referring to step 120 of FIG. 1, with the lithium hydroxide solution disclosed above comprises at least a lanthanum precursor and a zirconium precursor to form a powder mixture. For example, the precursor blend may comprise oxides or oxide precursors of lanthanum and zirconium. In addition, the precursor blend may comprise oxides or oxide precursors of dopants as described below.

In some embodiments, the precursor blend includes oxide powders or precursors of lanthanum oxide (La₂O₃) and zirconium oxide (ZrO₂) for mixing with the lithium hydroxide solution. The lanthanum precursor may comprise lanthanum hydroxide, e.g., La(OH)₃ and others, or lanthanum oxide or a combination thereof. The lanthanum precursor may be anhydrous. Lanthanum oxide in the precursor blend may be used in the presence of water in order to hydrate to form La(OH)₃. In some embodiments, the precursor blend includes lanthanum oxide for mixing in a powder blend as a slurry. In other embodiments, a precursor blend comprises powders of lanthanum hydroxide, zirconium oxide, aluminum oxide, tantalum oxide, and/or niobium oxide, which are mixed with lithium hydroxide and/or lithium hydroxide monohydrate in solution to form a powder mixture. In embodiments using lanthanum hydroxide in the precursor blend, milling the powder mixture in one or more solvents forms a powder mixture slurry.

The zirconium precursor may comprise zirconium oxide or zirconium hydroxide [Zr(OH)₄].

The precursor blend may further comprise a dopant or dopants. The precursor blend may include at least one of the following dopant oxides (or precursors thereof) as minor addition(s): aluminum oxide (Al₂O₃), tantalum oxide (Ta₂O₅), and niobium oxide (Nb₂O₅). Other forms of these oxides are also suitable as initial oxides, e.g., niobium monoxide (niobium(II) oxide, NbO) niobium dioxide (niobium(IV) oxide, NbO₂). Other dopants suitable for including in the precursor blend include oxides, or precursors thereof, of gallium (Ga) and/or indium (In). Dopant or dopants may include nitrate salts thereof. The precursor blend may include, for example, aluminum nitrate, tantalum nitrate, niobium nitrate, and the like. Dopant atoms of +3 oxidation state and appropriate ionic radius such as Al+3 and Ga+3 or, alternatively, dopant atoms of Ta+5 and Nb+5, may contribute to high cubic garnet phase purity as aliovalent substitutes for lithium atoms in the garnet crystal structure.

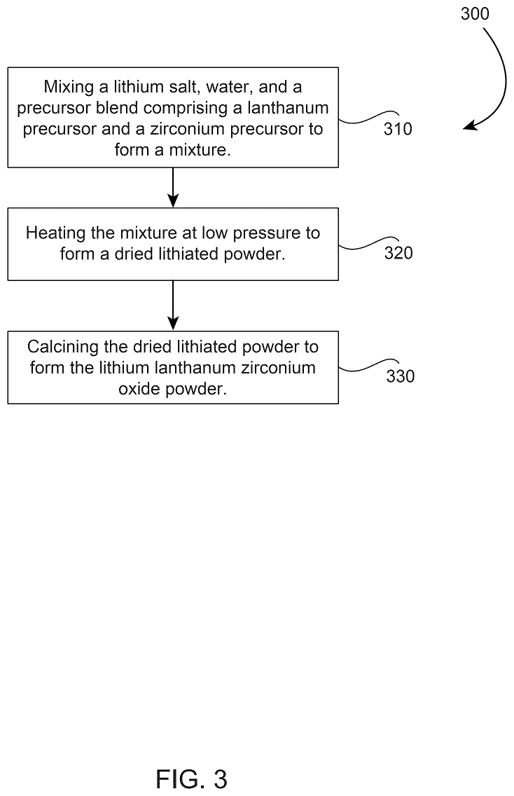

In an exemplary process as in FIG. 3, the process 300 of synthesizing a lithium lanthanum zirconium oxide powder includes mixing a lithium salt, water, and a precursor blend comprising a lanthanum precursor and a zirconium precursor to form a mixture as in 310. The process further includes heating the mixture at low pressure to form a dried lithiated powder as in 320. The process further includes calcining the dried lithiated powder to form the lithium lanthanum zirconium oxide powder as in 330. Lithium salts suitable for use in the process 300 include lithium slats having a melting point of less than 605° C. Lithium salts as in processes herein may exclude lithium acetate.

Mixing 310 the precursor blend may include that the lanthanum precursor is lanthanum hydroxide or lanthanum oxide or a combination thereof; and the zirconium precursor is zirconium oxide or zirconium hydroxide or a combination thereof. The precursor blend may include oxide powders or precursors of lanthanum oxide (La₂O₃), zirconium oxide (ZrO₂), and optionally aluminum oxide (Al₂O₃). In some embodiments, the precursor blend includes lanthanum oxide and zirconium oxide. In other embodiments, the precursor blend includes lanthanum oxide, zirconium oxide, and aluminum oxide.

In some embodiments, the precursor blend further includes a dopant. The dopant may be selected from an aluminum precursor, a tantalum precursor, a niobium precursor, a gallium precursor, or an indium precursor, or combinations thereof. The dopant may be an oxide or a hydroxide of Al, Ta, Nb, Ga, In, or combinations thereof.

Process 300 may include milling the lanthanum precursor and the zirconium precursor (and optionally a dopant) in the presence of water to form a slurry. The process may include drying the slurry to form the precursor blend before mixing 310 with the lithium salt. Drying the slurry may be performed in air or in vacuum. The precursor blend may include particles having a d₉₀ of less than 10 microns. Alternatively or in addition, the precursor blend may have an average particle size of less than 5 microns, less than 3 microns, less than 2 microns, or less than 1 micron.

The lithium salt may include lithium citrate, lithium hydroxide, lithium nitrate, or hydrates thereof, or combinations thereof. In some embodiments, the lithium salt consists of lithium citrate, lithium hydroxide, lithium nitrate, or hydrates thereof, or combinations thereof.

The lithium salt may include lithium hydroxide or lithium nitrate, or hydrates thereof, or combinations thereof. In some embodiments, the lithium salt consists of lithium hydroxide or lithium nitrate, or hydrates thereof, or combinations thereof.

In a particular embodiment, the lithium salt is lithium hydroxide, lithium hydrate, or combinations thereof. In another particular embodiment, the lithium salt is lithium nitrate.

The mixture may include from 55 wt % to 75 wt % lanthanum oxide and from 25 wt % to 40 wt % zirconium oxide, based upon total weight of the mixture. The mixture may further include from 0.5 wt % to 5 wt % of aluminum oxide, tantalum oxide, or niobium oxide, or combinations thereof based upon total weight of the mixture. The mixture may include from 15 wt % to 35 wt % of lithium hydroxide and/or lithium hydroxide monohydrate, based upon total weight of the mixture.

Heating 320 the mixture at low pressure may include heating to a temperature from 85° C. to 135° C. at a pressure of from 51 kPa to 101 kPa. Heating 320 the mixture at low pressure may include heating to a temperature from 85° C. to 135° C., with a vacuum of greater than 91.4 kPa, for a time of from 8 hours to 16 hour to remove the water from the mixture to form the dried lithiated powder. In a particular embodiment, the mixture is heated to 110° C. with a vacuum of greater than 91.4 kPa for a time of 8 hours.

Calcining 330 the dried lithiated powder may include calcining to a temperature from 900° C. to 1100° C. for a time of from 4 hours to 12 hour to form the lithium lanthanum zirconium oxide powder. In a particular embodiment, the dried lithiated powder is calcined at a temperature of 1050° C. for 8 hours.

Process 300 yields a lithium lanthanum zirconium oxide powder having high cubic garnet phase purity. The powder may have a cubic garnet phase purity of greater than 20 wt %, greater than 50 wt %, greater than 75 wt %, greater than 85 wt %, greater than 90 wt %, or greater than 95 wt %. The lithium lanthanum zirconium oxide powder may have less than 5 wt % impurities (e.g., phases other than cubic garnet LLZO).

The dopant oxides provide doping to the resultant Li₇La₃Zr₂O₁₂ (LLZO) powder after calcining with cations taking the place of some of the lithium cations in the lattice structure. Dopant oxides are not limited to aluminum oxide, tantalum oxide, and niobium oxide as mentioned above and may comprise Al³⁺, Ta⁵⁺, Nb⁵⁺, Ga³⁺, In³⁺, or combinations thereof. Besides contributing to higher cubic garnet phase purity, different cation doping can be used to achieve more stable LLZO with a higher ionic conductivity and lower activation energy. The dopants can be tailored to specific applications.

In some embodiments, the precursor blend comprises oxides and/or oxide precursors of lanthanum, zirconium, aluminum, tantalum, niobium, gallium, and/or indium. For example, dopant oxides or oxide precursors may comprise an aluminum oxide precursor, a tantalum oxide precursor, a niobium oxide precursor, a gallium oxide precursor, an indium oxide precursor, aluminum oxide, tantalum oxide, niobium oxide, gallium oxide, indium oxide, or combinations thereof.

In some cases, the initial oxide powder(s) or oxide precursor(s) are high purity powders. For example, the powder of lanthanum oxide, zirconium oxide, aluminum oxide, tantalum oxide, niobium oxide, gallium oxide, and/or indium oxide may have a purity greater than (and including) 2N (99%), e.g., 3N (99.9%), 3N5 (99.95%), or 4N (99.99%). In some embodiments, the oxide powder has a purity of 3N. In some cases, the oxide powder has a purity greater than (and including) 3N or greater than (and including) 3N5.

Suitable precursor powders are commercially available, e.g., La(OH)₃. Suitable oxide powders, e.g., lanthanum oxide, zirconium oxide, and aluminum oxide, are commercially available.

In some embodiments, the precursor blend is (thoroughly) blended prior to mixing with the lithium hydroxide solution. Blending can include milling. The precursor blend may be blended by milling the raw materials together (e.g., precursors of lanthanum, zirconium, and optional dopants) until a desired particle size is attained in the precursor blend. Milling time of the precursor blend can vary depending on scale of operation (raw material batch sizes). In some embodiments, the precursor blend is blended in a range from 1 hour to 24 hours or more. For example, the precursor blend is blended from 1 hour to 24 hours, e.g., from 1 hour to 12 hours, or from 1 hour to 6 hour. In terms of lower limits, the precursor blend may be blended for greater than 1 hour, e.g., greater than 2 hours, greater than 3 hours, or greater than 6 hours. In terms of upper limits, the precursor blend may be blended for less than 24 hours, e.g., less than 12 hours, or less than 6 hours. When scaling up to larger batch sizes, e.g., greater than 20 kg, the precursor blend may be blended for greater than 24 hours.

In some embodiments, mixing can be conducted via incipient wetness impregnation. Incipient wetness impregnation used herein means that the precursor blend is impregnated with the lithium-containing lithium hydroxide solution and dried. In some embodiments, mixing the lithium hydroxide solution with a precursor blend includes impregnating the precursor blend with the lithium hydroxide solution via incipient wetness impregnation.

The process herein may include where the precursor blend as referred to above is prepared “dry”, e.g., components for the precursor blend are milled together “neat” in a planetary media mill, a ball mill, attritor media mill, or the like, and milled with or without grinding media in a container without added solvent(s). Alternatively, the precursor blend may be prepared by milling an oxide blend comprising powders of lanthanum oxide, zirconium oxide, aluminum oxide, tantalum oxide, niobium oxide, gallium oxide, and/or indium oxide and water or another solvent. The process then includes drying the oxide blend to form the precursor blend. The oxide blend may comprise powders of lanthanum oxide, zirconium oxide, aluminum oxide, tantalum oxide, niobium oxide, gallium oxide, and/or indium oxide. In another example, the precursor blend may be prepared milling oxide precursor powders of lanthanum, zirconium, aluminum, tantalum, niobium, gallium, and/or indium and water, then drying the oxide precursor blend to form the precursor blend.

The average particle size of the oxide or oxide precursor powder(s) may vary widely. For example, the oxide or oxide precursor powders may have an average particle size ranging from 0.001 μm to 50 μm, e.g., from 0.005 μm to 25 μm, from 0.01 μm to 10 μm, or from 0.01 μm to 5 μm. In terms of lower limits, the average particle size of the oxide or oxide precursor powders may be greater than 0.001 μm, e.g., greater than 0.005 μm, or greater than 0.01 μm. In terms of upper limits, the average particle size of the oxide or oxide precursor powders may be less than 50 μm, e.g., less than 25 μm, less than 10 μm, less than 5 μm, or less than 1 μm. The average particle size of the oxide or oxide precursor powder(s) is not a dominant factor in predicting, for example, the completeness of the phase transformation to cubic garnet LLZO upon calcining.

In some embodiments, the powders in the oxide blend comprise particles having a d₉₀ of less than 10 microns. In other embodiments, the powders in the oxide blend comprise particles having a d₉₀ of less than 1 micron.

### Mixing

Referring again to FIG. 1, the process includes mixing 120 the lithium hydroxide solution with the precursor blend. Mixing can include dry milling as described above. Preferably, mixing is conducted “wet” in which the powder mixture is milled together as a slurry in a solvent that the raw materials are all insoluble in. Examples include water and alcohols (e.g., isopropanol, ethanol, methanol), toluene, and/or xylenes. Milling the powders wet as a slurry is highly advantageous as it allows for more efficient milling to smaller particle sizes. These smaller particle sizes allow for better reactivity of the raw materials (better reactivity means the products can be formed at lower temperatures and/or shorter times during calcining). Wet milling can include ball milling the powder mixture in the presence of milling media and a solvent to form a powder slurry. Greater than one of the benefits of the process disclosed herein is that water may be used as the solvent for dissolving lithium hydroxide in solution, thus is the solvent for the mixing preferably herein. This means that deleterious solvents that are less friendly to the environment, e.g., isopropanol, ethanol, methanol, toluene, and/or xylenes, are not required in the processes herein. Processes herein may be devoid of or substantially devoid of solvents that contain isopropanol, ethanol, methanol, toluene, and/or xylene, and the like. In embodiments using lanthanum hydroxide or lanthanum oxide in the precursor blend, for example, an aqueous solution is used optionally with an organic dispersant to keep the particles suspended and deagglomerated in the slurry.

In some cases, mixing includes ball milling, which may be performed in a polymer lined ball milling vessel. The diameter of the vessel may range from 15 cm to 60 cm in diameter and from 15 cm to 60 cm in height. The ball milling may be performed in a non-reactive vessel, such as a polyurethane lined milling jar, e.g., an Abbethane jar with lifters unit by Paul O'Abbe (Bensenville, IL), with dimensions of (30 cm diameter×30 cm height). The contents of the polymer lined ball milling vessel include the precursor blend, the lithium hydroxide solution, and milling media. The solvent may be distilled water or deionized water. The amount of solvent ranges from 30 to 60 wt % based upon the total weight of the powder mixture.

The ball milling may be conducted at a speed ranging from 15 RPM to 70 RPM. For example, the ball milling speed may be from 15 RPM to 70 RPM, e.g., 30 RPM to 70 RPM, or from 50 RPM to 70 RPM. Ball milling may be performed for a time from 1 hour to 64 hours. For example, the ball milling time may be from 1 hour to 64 hours, e.g., 4 hours to 48 hours, 8 hours to 24 hours, or from 12 hours to 20 hours. In some embodiments, ball milling is performed at 60 RPM for 16 hours. The milling media may be cylindrical or spherical or other shape with dimensions of about 13 mm in diameter and/or height. For example, the grinding media may be from 10 mm to 20 mm in diameter and from 10 mm to 20 mm in height, e.g., from 12 mm to 18 mm in diameter and from 12 mm to 18 mm in height, or from 13 mm to 16 mm in diameter and from 13 mm to 16 mm in height.

Mixing of the process herein may include milling media added to the mixture of the precursor blend and the lithium hydroxide solution. The milling media may be ceramic milling media, e.g., alumina and/or yttria stabilized zirconia (YSZ). In some embodiments, mixing includes milling the precursor blend/lithium hydroxide solution with YSZ milling media due to its hardness relative to alumina. The YSZ milling media is long-lasting and is not prone to imparting impurities into the powder mixture.

Alumina milling media according to embodiments is of high purity. In some embodiments, the alumina grinding media has a purity of from 95.0% to 99.99% Al₂O₃. For example, the alumina grinding media has a purity from 95.0% to 99.9% Al₂O₃, e.g., from 95.0% to 99.8% Al₂O₃, from 97.0% to 99.8% Al₂O₃, from 98.0% to 99.8% Al₂O₃, from 99.0% to 99.8% Al₂O₃, or from 99.5% to 99.8% Al₂O₃. In terms of lower limits, the alumina grinding media has a purity greater than 95.0% Al₂O₃, e.g., greater than 95.0% Al₂O₃, greater than 96.0% Al₂O₃, greater than 97.0% Al₂O₃, greater than 98.0% Al₂O₃, greater than 99.0% Al₂O₃, greater than 99.5% Al₂O₃, greater than 99.8% Al₂O₃, or greater than 99.9% Al₂O₃. In terms of upper limits, the alumina grinding media has a purity less than 100% Al₂O₃, e.g., less than 99.99% Al₂O₃, less than 99.9% Al₂O₃, or less than 99.8% Al₂O₃. In some embodiments, the alumina grinding media has a purity from 95.0% to 99.8% Al₂O₃.

Yttria stabilized zirconia milling media according to embodiments is of high purity. In some embodiments, the YSZ grinding media has a purity of from 95.0% to 99.99% YSZ. For example, the YSZ grinding media has a purity from 95.0% to 99.9% YSZ, e.g., from 95.0% to 99.8% YSZ, from 97.0% to 99.8% YSZ, from 98.0% to 99.8% YSZ, from 99.0% to 99.8% YSZ, or from 99.5% to 99.8% YSZ. In terms of lower limits, the YSZ grinding media has a purity greater than 95.0% YSZ, e.g., greater than 95.0% v, greater than 96.0% YSZ, greater than 97.0% v, greater than 98.0% YSZ, greater than 99.0% YSZ, greater than 99.5% YSZ, greater than 99.8% v, or greater than 99.9% YSZ. In terms of upper limits, the YSZ grinding media has a purity less than 100% YSZ, e.g., less than 99.99% YSZ, less than 99.9% YSZ, or less than 99.8% YSZ. In preferred embodiments, the YSZ grinding media has a purity from 95.0% to 99.8% YSZ.

The alumina and/or YSZ milling media have a diameter ranging from 0.25 mm to 25 mm. The alumina and/or YSZ milling media is wear resistant with a Vickers hardness of 14 GPa (±10%) and a density of from 3.88 g/cm³ to 3.97 g/cm³ for alumina; and a Vickers hardness of 12.5 GPa (±10%) and a density of from 5.85 g/cm³ to 6.10 g/cm³ for YSZ.

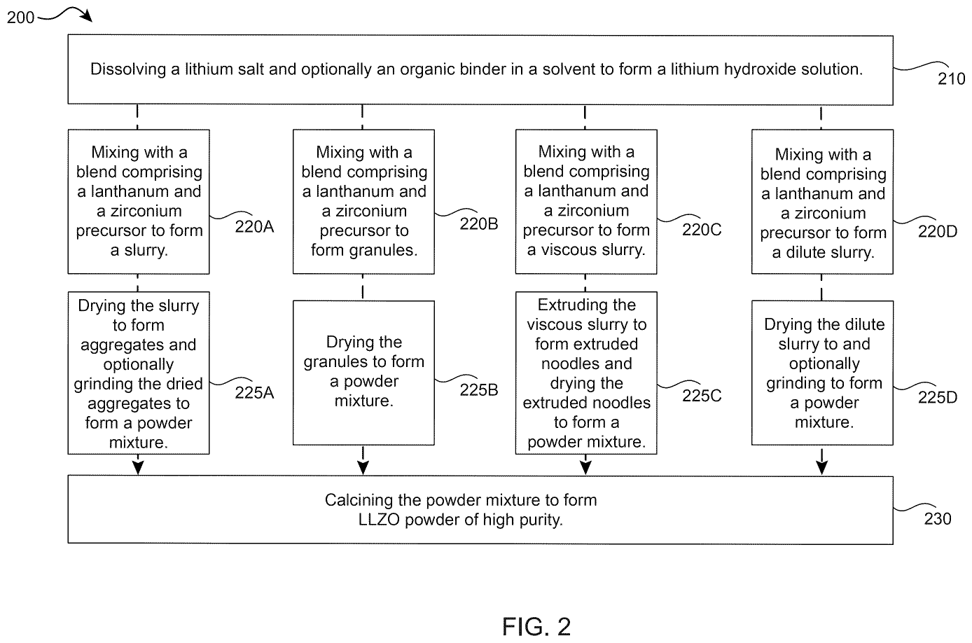

As illustrated in FIG. 2, the LLZO powders of high purity may be synthesized in alternative routes.

In an aspect, processes herein include that the lithium hydroxide solution is mixed with the precursor blend to produce a powder mixture that is a slurry. This is illustrated in the process 200 of FIG. 2 as shown including steps 220A and 225A. The slurry may have a viscosity ranging from 10 cps to 100,000 cps. In some embodiments, the process includes a slurry having a viscosity ranging from 10 cps to 100,000 cps, e.g., from 100 cps to 10,000 cps, or from 100 cps to 1000 cps. In terms of upper limits, the process includes a slurry having a viscosity less than 100,000 cps, e.g., less than 10,000 cps, less than 1000 cps. In terms of lower limits, the process includes a slurry having a viscosity greater than 10 cps, e.g., greater than 100 cps. The slurry may be devoid of additional ingredients, e.g., binders.

The slurry is then dried under vacuum or using an inert gas (e.g., nitrogen or argon) at a temperature ranging from 105° C. to 150° C. The dried slurry forms aggregates, and the powder mixture (ready for calcining) is formed by crushing and sieving the aggregates.

Processing may optionally include grinding the dried aggregates to form the powder mixture. Alternatively, or in addition to grinding, processing the dried aggregates may include sieving to attain the desired size. For example, the dried aggregates can be sieved to obtain a powder mixture according to desired size of particles (and/or desired size of agglomerates).

In some embodiments, the powder mixture has an average particle size distribution of less than 100 μm. For example, useful sieve sizes can include a 230 mesh sieve or a 325 mesh sieve. Passing through a 230 mesh sieve, the powder mixture may have an average particle size distribution of less than 63 μm. Passing through a 325 mesh sieve, the powder mixture may have an average particle size distribution of less 44 μm. In other embodiments, it may be desired that the powder mixture have an average particle size distribution of greater than 100 μm. This powder mixture (as in step 225A) is then calcined as described below to form LLZO of high purity.

In another aspect, dissolving as in processes herein include dissolving the lithium salt and an organic binder in a solvent to form the lithium hydroxide solution. The solvent is preferably water, and can alternatively be solvents as described herein. Further, lithium hydroxide solution may be mixed with an organic binder, e.g., polyvinyl alcohol (PVA) prior to mixing with the precursor blend. Suitable organic binders are preferably water soluble. Organic binders according to the disclosure herein may include, but are not limited to, acrylic polymer based ammonium solution (B-60A, commercially available from Rohm and Haas), or polyvinyl alcohol solution, or the like. This is illustrated in the process 200 of FIG. 2 including steps 210, 220B, and 225B.

Granulating can be a critical intermediate processing step to provide a more flowable particle size that facilitates continuous thermal processing and automated material transport. To form the granules, the dried powder is combined in a mixer with a solution of water and organic binder blended with the dried powder. Embodiments herein include forming granules, following processing as described above. The organic binder is useful for granulating, in a mixer, the precursor blend and lithium hydroxide/organic binder solution to form granules. Without being bound by theory, improved phase purity may be in part due to the water added during granulating providing for a particle morphology that allows for increased air flow during calcination.

The solution of water and binder acts to bind the particles into granules. Once the water has been added, lithium hydroxide in the granules will be fully hydrated to form LiOH—H₂O. Without being bound by theory, granulating is believed to provide for shorter calcining times as compared with powder mixtures formed without granulating.

Granulating the dried powder is conducted, e.g., by grinding and/or sieving processes, to form granules in a size range of about 0.5 mm to about 5 mm.

Similarly as for the slurry described above, the granules are then dried under vacuum or using an inert gas (e.g., nitrogen or argon) at a temperature ranging from 105° C. to 150° C. to form the powder mixture. The resulting powder mixture (as in step 225B) is then calcined as described below to form LLZO of high purity.

In yet another aspect, processes herein include dissolving the lithium salt and an organic binder, e.g., PVA, in a solvent to form the lithium hydroxide solution. This is illustrated in the process 200 of FIG. 2 including steps 220C and 225C. The lithium hydroxide solution (including PVA) is mixed with the precursor blend to produce a viscous slurry which is fed into an extruder.

In some embodiments, mixing is conducted in a blender and forms a viscous slurry. The viscous slurry may have a viscosity ranging from 1000 cps to 25,000 cps. In some embodiments, the process includes a slurry having a viscosity ranging from 1000 cps to 25,000 cps, e.g., from 1000 cps to 20,000 cps, or from 2000 cps to 15,000 cps. In terms of upper limits, the process includes a slurry having a viscosity less than 25,000 cps, e.g., less than 20,000 cps, less than 15,000 cps. In terms of lower limits, the process includes a slurry having a viscosity greater than 1000 cps, e.g., greater than 2000 cps.

Processing the viscous slurry into an extruder produces elongated aggregates, resembling wet “noodles”, that are then dried under vacuum or using an inert gas (e.g., nitrogen or argon) at a temperature ranging from 105° C. to 150° C. These dried noodles form the powder mixture, which is then calcined as described below.

In another aspect, processes herein include dissolving the lithium salt and an organic binder, e.g., PVA, in a solvent to form the lithium hydroxide solution to produce a dilute slurry that is spray dried to give flowable powders. This is illustrated in the process 200 of FIG. 2 including steps 220D and 225D.

In an exemplary process as in FIG. 3, the oxide slurry is mixed with a lithium salt to form a mixture at step 330 as in FIG. 3. Additional water may be added during mixing if needed.

In some embodiments, mixing the precursor blend with the lithium hydroxide solution (and PVA) forms a dilute slurry. In some embodiments, the process includes a dilute slurry having a viscosity ranging from 1 cps to 1000 cps, e.g., from 1 cps to 750 cps, or from 1 cps to 500 cps. In terms of upper limits, the process includes a dilute slurry having a viscosity less than 1000 cps, e.g., less than 750 cps, or less than 500 cps. In terms of lower limits, the process includes a dilute slurry having a viscosity greater than 1 cps, e.g., greater than 10 cps. The processed slurry is then dried under vacuum or using an inert gas (e.g., nitrogen or argon) at a temperature ranging from 105° C. to 150° C. to form a powder mixture then calcined as described below.

Mixing the lithium hydroxide solution with the precursor blend forms a powder mixture. In some embodiments, the powder mixture comprises from 40 wt % to 60 wt % lanthanum oxide, where wt % is based upon total weight of the powder mixture. For example, the powder mixture may comprise from 40 wt % to 60 wt % lanthanum oxide, e.g., from 45 wt % to 60 wt %, from 45 wt % to 58 wt %, from 46 wt % to 55 wt %, or from 47 wt % to 54 wt %. In terms of lower limits, the powder mixture may comprise greater than 40 wt % lanthanum oxide, e.g., greater than 45 wt %, greater than 46 wt %, or greater than 47 wt %. In terms of upper limits, the powder mixture may comprise less than 60 wt % lanthanum oxide, e.g., less than 58 wt %, less than 55 wt %, or less than 54 wt %. In some embodiments, lanthanum oxide is included in the amount from 47 wt % to 54 wt % based upon the total weight of the powder mixture.

In some embodiments, the powder mixture comprises from 20 wt % to 30 wt % zirconium oxide, where wt % is based upon total weight of the powder mixture. For example, the powder mixture may comprise from 20 wt % to 30 wt %, e.g., from 21 wt % to 29 wt %, from 22 wt % to 28 wt %, or from 23 wt % to 27 wt %. In terms of lower limits, the powder mixture may comprise greater than 20 wt % zirconium oxide, e.g., greater than 21 wt %, greater than 22 wt %, or greater than 23 wt %. In terms of upper limits, the powder mixture may comprise less than 30 wt % zirconium oxide, e.g., less than 29 wt %, less than 28 wt %, or less than 27 wt %. In some embodiments, zirconium oxide is included in the amount from 23 wt % to 27 wt % based upon the total weight of the powder mixture.

Optionally, a dopant is included in the powder mixture. Thus, the powder mixture comprises small amounts, if any, aluminum oxide in some embodiments. In other embodiments, the powder mixture is devoid or substantially devoid of aluminum oxide. In some embodiments, the powder mixture comprises from 0.5 wt % to 5 wt % aluminum oxide, where wt % is based upon total weight of the powder mixture. For example, the powder mixture may comprise from 0.5 wt % to 5 wt % aluminum oxide, e.g., from 0.5 wt % to 4 wt %, from 1 wt % to 3 wt %, or from 1 wt % to 2 wt %. In terms of lower limits, the powder mixture may comprise greater than 0.5 wt % aluminum oxide, e.g., greater than 0.5 wt % or greater than 1 wt %. In terms of upper limits, the powder mixture may comprise less than 5 wt % aluminum oxide, e.g., less than 4 wt %, less than 3 wt %, or less than 2 wt %. In some embodiments, aluminum oxide is included in the amount from 1 wt % to 4 wt % based upon the total weight of the powder mixture.

In some cases, the powder mixture comprises one or more dopants. The powder mixture may comprise one or more dopants chosen from aluminum oxide, tantalum oxide, and niobium oxide. Thus in some embodiments, the powder mixture comprises small amounts, if any, one or more dopants chosen from aluminum oxide, tantalum oxide, and niobium oxide. In other embodiments, the powder mixture is devoid or substantially devoid of aluminum oxide, tantalum oxide, and niobium oxide. Aluminum oxide, tantalum oxide, and niobium oxide may be referred to as dopant oxide(s). In some embodiments, the powder mixture comprises from 0.5 wt % to 5 wt % dopant oxide(s), where wt % is based upon total weight of the powder mixture. For example, the powder mixture may comprise from 0.5 wt % to 5 wt % dopant oxide(s), e.g., from 0.5 wt % to 5 wt %, from 1 wt % to 5 wt %, from 0.5 wt % to 4 wt %, from 1 wt % to 3 wt %, or from 1 wt % to 2 wt %. In terms of lower limits, the powder mixture may comprise greater than 0.5 wt % dopant oxide(s), e.g., greater than 0.5 wt % or greater than 1 wt %. In terms of upper limits, the powder mixture may comprise less than 5 wt % dopant oxide(s), e.g., less than 5 wt %, less than 4 wt %, less than 3 wt %, or less than 2 wt %. In some embodiments, dopant oxide(s) are included in the amount from 1 wt % to 5 wt % based upon the total weight of the powder mixture.

In some embodiments, the powder mixture comprises from 15 wt % to 35 wt % lithium hydroxide and/or lithium hydroxide monohydrate, where wt % is based upon total weight of the powder mixture. The powder mixture may contain anhydrous and hydrated forms. For example, the powder mixture may comprise from 15 wt % to 35 wt % lithium hydroxide and/or lithium hydroxide monohydrate, e.g., from 15 wt % to 35 wt %, from 16 wt % to 27 wt % monohydrate, or from 18 wt % to 25 wt %. In terms of lower limits, the powder mixture may comprise greater than 15 wt % lithium hydroxide and/or lithium hydroxide monohydrate, e.g., greater than 16 wt %, greater than 17 wt %, or greater than 18 wt %. In terms of upper limits, the powder mixture may comprise less than 30 wt % lithium hydroxide and/or lithium hydroxide monohydrate, e.g., less than 27 wt %, less than 26 wt %, or less than 25 wt %. In some embodiments, lithium hydroxide and/or lithium hydroxide monohydrate is included in the amount from 16 wt % to 27 wt % based upon the total weight of the powder mixture. In an example using anhydrous LiOH, lithium hydroxide is included in an amount from 16.5 wt % to 17.6 wt % based upon the total (dry) weight of the powder mixture. In an example using LiOH—H₂O, lithium hydroxide monohydrate is included in an amount from 25.2 wt % to 26.8 wt % based upon the total (dry) weight of the powder mixture.

### Drying

The powder mixture as in any of the disclosed processes can be dried to remove excess moisture such as drying in a suitable dryer, e.g., a Fisher Scientific Lab drying oven. Drying may include under vacuum or using an inert gas (e.g., nitrogen or argon) at a temperature ranging from 105° C. to 150° C. Drying may include purging with inert gas, which is greater than 90% effective at displacing air. In some embodiments, drying is performed at a temperature less than 90° C. Drying may be performed for a time of from 2 hours to 24 hours. Inventors of the present invention found surprisingly that drying by heating at a low pressure, e.g., under vacuum, provided high phase purity for cubic LLZO, whereas omitting this drying led to a powder yielding tetragonal LLZO as the major phase instead of cubic LLZO. In an exemplary embodiment, a mixture formed by mixing a lithium salt with the milled powder is then dried by heating to 110° C. with a vacuum of greater than 91.4 kPa (27″ Hg) for 12 hours to remove the water from the mixture. This forms a dried powder, wherein the dried powder is lithiated powder, as shown in FIG. 3 at step 320.

Drying by heating the mixture at low pressure may include heating to a temperature from 85° C. to 135° C. at a pressure of from 51 kPa to 101 kPa.

The temperature at which the low pressure drying is performed ranges from 85° C. to 135° C. For example, low pressure drying is performed from 85° C. to 135° C., e.g., from 95° C. to 125° C., from 100° C. to 120° C., or from 105° C. to 115° C. In terms of lower limits, the low pressure drying may be performed at a temperature of greater than 85° C., e.g., greater than 95° C., greater than 100° C., or greater than 105° C. In terms of upper limits, the low pressure drying may be performed at a temperature less than 135° C., e.g., less than 125° C., less than 120° C., or less than 115° C. In preferred embodiments, the low pressure drying is performed at a temperature of from 105° C. to 115° C.

The low pressure drying may be performed with a vacuum. The pressure at which the low pressure drying is performed ranges from 51 kPa to 101 kPa or from 50.66 kPa to 101.33 kPa. For example, low pressure drying is performed from 50.66 kPa to 101.33 kPa, e.g., from 60.80 kPa to 99.40 kPa, from 70.93 kPa to 97.98 kPa, or from 81.06 kPa to 94.64 kPa. In terms of lower limits, the low pressure drying may be from greater than 50.66 kPa, e.g., greater than 60.80 kPa, greater than 70.93 kPa, or greater than 81.06 kPa. In terms of upper limits, the low pressure drying may be performed from less than 135° C., e.g., less than 101.33 kPa, less than 99.40 kPa, less than 97.98 kPa, or less than 94.64 kPa. In preferred embodiments, the low pressure drying is performed at 91.40 kPa.

Low pressure drying may be performed at temperatures/pressures described above for a time that ranges from 1 hour to 24 hours. For example, low pressure drying is performed for 1 hour to 24 hours, e.g., from 2 hour to 20 hours, from 4 hours to 18 hours, or from 8 hours to 16 hours. In terms of lower limits, the low pressure drying may be performed for a time greater than 1 hour, e.g., greater than 2 hours, greater than 4 hours, or greater than 8 hours. In terms of upper limits, the low pressure drying may be performed for a time less than 24 hours, e.g., less than 20 hours, less than 18 hours, or less than 16 hours.

Further, to minimize carbonate formation, humidity levels of the powder mixture formed may be controlled. For example, hydration of LiOH to LiOH—H₂O can lead to carbonate formation, e.g., lithium carbonate Li₂CO₃. While less likely, La₂O₃ (or ZrO₂, Al₂O₃, or other oxides) present prior to calcination may also form carbonates, e.g., lanthanum carbonate, La₂(CO₃)₃, [or (ZrO)₂(OH)₂CO₃, Al₂(CO₃)₃, or other carbonates]. La₂O₃ tends to form La(OH)₃ in the presence of moisture. Thus, drying and storing the powder mixture (prior to calcining) must be done with care to protect from exposure to carbon dioxide and/or humidity, preferably both, to ensure a high phase purity (cubic garnet LLZO) after calcining.

### Calcining

Calcining the powder mixture is then conducted to form lithium lanthanum zirconium oxide powder. Calcining is heating to a desired temperature to effect a phase transformation to cubic garnet LLZO without sintering. Importantly, the calcining, in some embodiments, is conducted at temperatures below what it conventionally considered sintering temperatures, which, in some cases, avoids sintering. Further, the disclosed process steps make it possible for a lower temperature calcining—without these process steps, the calcining step would require higher temperatures and would encounter the troubles and detriments associated therewith.

The reaction mechanism involved during calcining according to embodiments herein takes advantage of the low melting point of LiOH, at about 462° C., to melt and react the dried granules early in the heating process to form an initial intermediate species that will then combine and crystalize into the garnet structure upon completion of the heating process. The intermediate species starts to immediately form at 462° C. and above and is critical to the reaction kinetics during calcining. The desired final cubic garnet species is formed upon completion of calcining.

Processes herein provide for minimal, if any, carbonate formation. Thus the reactant LiOH has been prevented from forming the carbonate, Li₂CO₃. Li₂CO₃ melts at a significantly higher temperature, at about 723° C., than lithium hydroxide, and the presence of any carbonate would alter the reaction pathway and lead to the formation of impurity phases to decrease the phase purity of the desired cubic garnet LLZO. Impurities include any phase (after calcining) that is not cubic garnet LLZO. Impurities include Li₂CO₃, tetragonal garnet LLZO, LiAlO₂, Li₂ZrO₃, and LaAlO₃, among others. The presence of these impurity phases is undesirable as they can reduce the ionic conductivity of the material and can cause subsequent defects during ceramic processing, which can include sintering.

Calcining provides for the transformation from dried granules to Li₇La₃Zr₂O₁₂, which optionally further includes dopants, e.g., Al³⁺, Ta⁵⁺, Nb⁵⁺, Ga³⁺, In³⁺, or combinations thereof as described above.

Calcining may be performed in any suitable furnace, e.g., an Armil furnace at a temperature ranging from 950° C. to 1150° C. for a time ranging from 1 to 10 hours. Calcining may be performed in air. Alternatively, calcining may be performed in an inert atmosphere (e.g., nitrogen or argon).

The temperature at which calcining is performed ranges from 950° C. to 1150° C. For example, calcining is performed from 950° C. to 1150° C., e.g., from 950° C. to 1125° C., from 950° C. to 1100° C., from 975° C. to 1100° C., from 975° C. to 1075° C., or from 1000° C. to 1050° C. In terms of lower limits, the calcining may be performed at a temperature greater than 950° C., e.g., greater than 975° C., or greater than 1000° C. In terms of upper limits, the calcining may be performed at a temperature less than 1150° C., e.g., less than 1125° C., less than 1100° C., less than 1075° C., or less than 1050° C. In preferred embodiments, the calcining is performed at a temperature of from 1000° C. to 1050° C.

Calcining may be performed at temperatures described above for a time that ranges from 1 hour to 10 hours. For example, calcining is performed for 1 hour to 10 hours, e.g., from 1 hour to 8 hours, from 1 hours to 6 hours, from 1 hours to 4 hours, or from 1 hour to 3 hours. In terms of lower limits, the calcining may be performed for a time greater than 1 hour, e.g., greater than 1 hour, greater than 2 hours, or greater than 3 hours. In terms of upper limits, the calcining may be performed for a time less than 10 hours, e.g., less than 8 hours, less than 6 hours, less than 4 hours, or less than 3 hours. Processes herein advantageously do not require long calcining times, e.g., greater than 12 hours, or greater than 16 hours, or greater than 24 hours.

In preferred embodiments, the calcining is performed for a time of from 1 to 3 hours. The time for calcining can depend on the furnace type. In one example, calcining is performed for a time of from 1 to 3 hours in a rotary kiln in a continuous process.

Calcining may be performed using a heat treatment schedule including one or more holds in a single calcining cycle. Each hold is associated with a temperature and a time at that temperature. In some embodiments, the calcining includes a heat treatment schedule that has one hold, two holds, three holds, four holds, or more. For example, calcining may include a first hold having a first temperature for a first time, a second hold having a second temperature for a second time, optionally a third hold having a third temperature for a third time, and optionally a fourth hold having a fourth temperature for a fourth time. In preferred embodiments, a single calcining cycle is used. For example, calcining is performed at a temperature of from 1000° C. to 1050° C. for a time of 1 hour to 3 hours.

Calcining may include a heating rate of from 2.0° C./min to about 3.3° C./min (or higher) using a batch kiln, such as a heating rate of preferably about 2.7° C./min. Calcining may include a heating rate of from 3.3° C./min to about 11.1° C./min using a rotary kiln. Calcining may include a cooling rate of from 2.0° C./min to about 3.3° C./min using a batch kiln, such as a cooling rate of preferably about 2.7° C./min. Calcining may include a cooling rate of from 3.3° C./min to about 11.1° C./min using a rotary kiln. In some instances, the furnace is simply turned off and thus the cooling rate is dependent upon the size of the kiln and the quantity of the powder that has been calcined.

Prior to calcining or included in the calcining cycle may be an additional hold for binder burnout. This hold is typically at a lower temperature than the hold temperatures for calcining, which effect the phase transformation to LLZO. The binder burnout can be performed as part of the ramping up heat to the calcining temperatures as detailed above. The temperature at which binder burnout is performed ranges from 400° C. to 600° C. For example, binder burnout is performed from 400° C. to 600° C., e.g., from 425° C. to 575° C., or from 450° C. to 550° C., or from 475° C. to 525° C. In terms of lower limits, the binder burnout may be performed at a temperature greater than 400° C., e.g., greater than 425° C., greater than 450° C., or greater than 475° C. In terms of upper limits, the binder burnout may be performed at a temperature less than 600° C., e.g., less than 575° C., less than 550° C., or less than 525° C. In preferred embodiments, the binder burnout is performed at a temperature of about 500° C.±10%.

Optionally calcining may be repeated. In preferred embodiments, only a single calcining is performed to provide the transformation to LLZO. In some embodiments calcining is repeated once, and in other embodiments twice. Process may include one, two, or three calcinations total. In some embodiments, calcining is repeated a maximum of one time. The processes herein are devoid of calcining more than three times in total.

It is believed that calcining temperature and/or time is not significantly affected by the dopants used, e.g., Al³⁺, Ta⁵⁺, Nb⁵⁺, Ga³⁺, In³⁺, or combinations thereof, to dope the LLZO. Dopants Ta⁵⁺ and/or Nb⁵⁺, being larger and heavier than Al³⁺, could require slightly higher temperatures or slightly longer heat times than for LLZO doped with Al³⁺, but not significantly, e.g., ±10%.

Optionally, after calcining the LLZO powder may undergo grinding and/or sieving. Useful sieve sizes can include a 80 mesh sieve. Passing through an 80 mesh sieve, the dried powder may have an average particle size distribution of less than 180 μm.

### LLZO Cubic Garnet Phase Purity and Composition

Calcining, importantly, affects the transformation of the dried lithiated powder to the lithium lanthanum zirconium oxide powder (LLZO), wherein the phase content may be determined by suitable techniques such as x-ray diffraction. LLZO is referred to herein generally as Li₇La₃Zr₂O₁₂, which may further be doped, and where the crystal structure is cubic garnet. The powder may have a cubic garnet phase purity of greater than 20 wt %, greater than 50 wt %, greater than 75 wt %, greater than 85 wt %, greater than 90 wt %, or greater than 95 wt %. The lithium lanthanum zirconium oxide powder may have less than 5 wt % impurities (e.g., phases other than cubic garnet LLZO). In some embodiments, the phase content of the LLZO powder includes greater than 95 wt % cubic garnet LLZO, e.g., greater than 96 wt % cubic garnet LLZO, greater than 97 wt % cubic garnet LLZO, greater than 98 wt % cubic garnet LLZO, greater than 98.5 wt % cubic garnet LLZO, greater than 99 wt % cubic garnet LLZO, or greater than 99.5 wt % cubic garnet LLZO. In some embodiments, the cubic garnet LLZO powder has a phase purity greater than 98% by weight, as measured by quantitative Rietveld refinement of powder x-ray diffraction data.

While phase purity is desired in some embodiments, processes herein may be used to incorporate dopants (as detailed above) and/or additional phases intentionally into synthesized lithium lanthanum zirconium oxide powders. The LLZO powder may be tailored to include additional phases by including excess of one or more elements to achieve a composition other than the stoichiometric Li₇La₃Zr₂O₁₂ composition.

Synthesized lithium lanthanum zirconium oxide powders according to processes herein may have the formula Li₇₋₃AlₓLa₃Zr₂O₁₂ as disclosed above but wherein x may be greater than 0.2 to provide excess Al to form one or more additional phases chosen from LaAlO₃, LiAlO₂, and La₂Zr₂O₇. The LLZO powders synthesized by processes herein may include: Li_{A}La_{B}M′_{C}M″_{D}Zr_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤≤E<2, 10<F<13, and M′ and M″ are each, independently in each instance selected from Al, Mo, W, Nb, Sb, Ca, Ba, Sr, Ce, Hf, Rb, and Ta; or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, V, W, Mo, and Sb; or LiₓLa₃Zr₂O_{12+y}Al₂O₃.

In some embodiments where LLZO is the primary phase (phase present in the greatest amount), secondary phases may include: tetragonal phase garnet Li₇La₃Zr₂O₁₂; La₂Zr₂O₇; La₂O₃; LaAlO₃; La₂(Li_{0.5}Al_{0.5})O₄; LiLaO₂; LiZr₂O₃; LiₐZr_{b}O_{c}, wherein 1≤a≤8, 1≤b≤2, and 1≤c≤7, and wherein subscripts a, b, and c are selected so that LiₐZr_{b}O_{c} is charge neutral; Li_{g}AlₕOᵢ, wherein 1≤g≤5, 1≤h≤5, and 2≤i≤8, and wherein subscripts g, h, i are selected so that Li_{g}AlₕOᵢ is charge neutral; La_{d}TaₑO_{f}, wherein 1≤d≤3, 1≤e≤7, and 4≤f≤19, and wherein subscripts d, e, and f are selected so that La_{d}TaₑO_{f} is charge neutral; LiᵣTaₛOₜ, wherein 1≤r≤2, 1≤s≤3, and 3≤t≤7, and wherein subscripts r, s, and t are selected so that LiᵣTaₛOₜ is charge neutral; LaₙNbₚO_{q}, wherein 1≤n≤3, 1≤p≤7, and 4≤q≤19, and wherein subscripts n, p, and q are selected so that LaₙNbₚO_{q} is charge neutral; LiᵤNbᵥOₓ, wherein 1≤u≤3, 1≤p≤3, and 3≤x≤9, and wherein subscripts u, v, and x are selected so that LiᵤNbᵥOₓ is charge neutral; and any combination thereof.

Additional phases present in the synthesized lithium lanthanum zirconium oxide powders may include: LiAlO, lithia (Li₂O), alumina (Al₂O₃), phosphorus oxide (P₂O₅), silica (SiO₂), titania (TiO₂), germanium oxide (GeO₂). In some embodiments the powders may be used to form a solid electrolyte selected from: Li₇La₃Zr₂O₁₂; Li_{0.38}La_{0.56}Ti_{0.99}Al_{0.01}O₃; or Li_{0.34}LaTiO_{2.94}; or Li₇La₃Zr₂O₁₂.

The impurity content of the LLZO powder includes less than 5 wt % of phases other than cubic garnet LLZO, e.g., less than 4 wt % impurities, less than 3 wt % impurities, less than 2 wt % impurities, less than 1.5 wt % impurities, less than 1 wt % impurities, or less than 0.5 wt % impurities. Impurities may be unavoidable and/or include unwanted secondary phases.

Advantageously in addition to being readily tailorable to desired dopants, the LLZO powder formed according to the processes herein can be readily sintered to a dense final article. Sintering by methods known in the art include solid state sintering, hot pressing, hot isostatic pressing, and others. The temperature at which sintering is performed is typically higher than the calcining temperatures of the processes herein. For example, sintering the LLZO is at temperatures from about 1200° C. or higher. LLZO powders as synthesized herein also may be used in tape casting to form thin films that are then sintered. Sintered LLZO may have a density of greater than 5.0 g/cc. Sintering may be performed at temperatures described above for a time that ranges from 2 hours to 64 hours. For example, sintering is performed for 2 hours to 64 hours, e.g., from 4 hours to 48 hours, from 6 hours to 24 hours, or from 8 to 16 hours, or from 10 to 14 hours. In terms of lower limits, the sintering may be performed for a time greater than 2 hours, e.g., greater than 4 hours, greater than 6 hours, greater than 8 hours, or greater than 10 hours. In terms of upper limits, the sintering may be performed for a time less than 64 hours, e.g., less than 48 hours, less than 24 hours, less than 16 hours, or less than 14 hours. In preferred embodiments, the sintering is performed for a time of from 8 to 16 hours.

In some embodiments, any or some of the components or steps disclosed herein may be considered optional. In some cases, the disclosed compositions may expressly exclude any or some of the aforementioned components or steps in this description, e.g., via claim language. For example, claim language may be modified to recite that the powder mixture does not utilize or comprise a component, e.g., the disclosed powder mixture does not comprise a particular oxide or dopant. Such negative limitations are contemplated, and this text serves as support for negative limitations for components, steps, and/or features.

### EXAMPLES

### Precursor Blend Preparation.

A precursor blend was prepared as follows.

Raw material powders were blended and included commercially available oxides of lanthanum, zirconium, and dopant aluminum in the amounts as follows to form a precursor blend: 605 g La₂O₃ (−200 mesh, 99.99%); 305 g ZrO₂ (−325 mesh); and 14 g Al₂O₃ (−200 mesh). The precursor blend included the dried oxide powder had a moisture content of less than 1.0 wt %.

The precursor blend was added to 1.5 L of deionized water and bead milled with yttria stabilized zirconia media (0.4 mm) to an average particle size of less than 1 micron.

The milled slurry was transferred to a stainless steel pan and dried in a convection oven at 105° C. in air for 24 hours to form a dried oxide powder.

### Example 1 (Ex. 1): Lithiation (LiOH—H₂O) (Low MP Salt) with Low Pressure Drying

Cubic garnet LLZO of Ex. 1 was synthesized as follows. The dried oxide powder (precursor blend as above) was lithiated with lithium salt LiOH—H₂O (low melting point of 462° C.). 50.0 g of the dried oxide powder along with 21.0 g of LiOH—H₂O were loaded into a 1 L stainless steel reactor. 150 ml of deionized water was added to the dried oxide powder/LiOH—H₂O blend to form a mixture. The mixture was stirred rapidly for 5 minutes.

The reactor was then heated to 110° C. at low pressure (vacuum) of 91.4 kPa (27″ Hg) for 12 hours to remove the water from the mixture, thus forming a dried lithiated powder. The dried lithiated powder was removed from the reactor and ground to a −40 mesh powder.

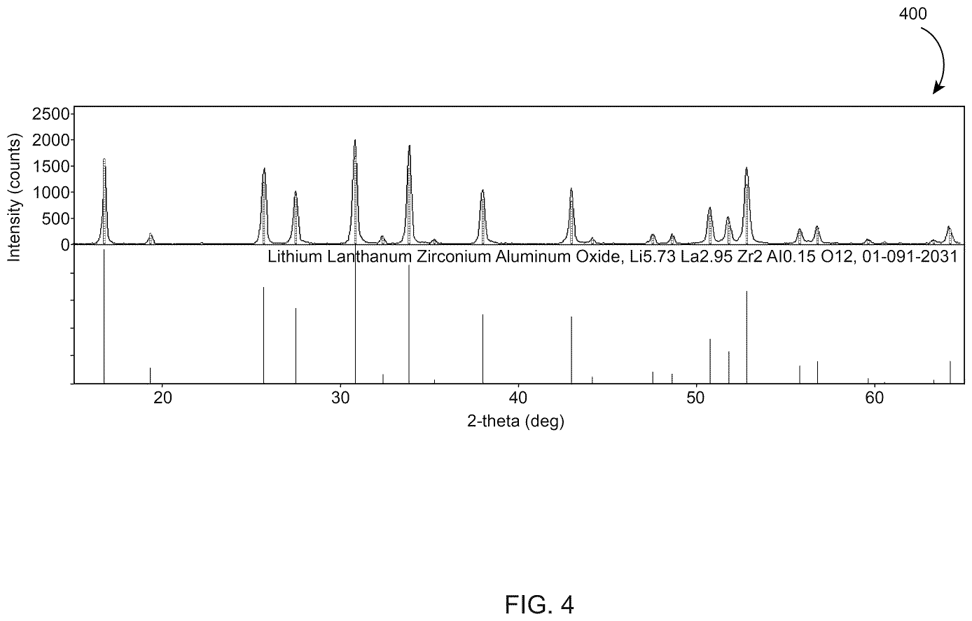

A 20 g portion of the dried lithiated powder was loaded into a corundum (Al₂O₃) combustion boat and calcined in air in an electric kiln for 8 hours at 1050° C. to form the lithium lanthanum zirconium oxide powder of high cubic garnet phase purity. The resultant powder, which was white in color, was analyzed by powder x-ray diffraction using a Rigaku MiniFlex powder x-ray diffractometer equipped with a copper source and data analyzed by Rigaku PDXL2 software. Rietveld refinement of the data found the material to be 97.4 wt % cubic LLZO phase with a trace impurity of 2.6 wt % LiAlO₂. The x-ray diffraction pattern for Ex. 1 is shown in FIG. 4.

### Comparative Example 1 (CE1): Lithiation (LiOH—H₂O) without Low Pressure Drying

To prepare CE1, 50.0 g of the dried oxide powder (precursor blend as above) was lithiated by mixing with 21.0 g of LiOH—H₂O and ball milled dry in a 1 L polyethylene jar with yttria stabilized zirconia media (9.5 mm or ⅜″) for 6 hours to form a lithiated powder. Notably, CE1 was dry ball milled to form a mixture. No water was added during ball milling, and no drying was performed (as in Ex. 1) prior to calcining the lithiated powder.

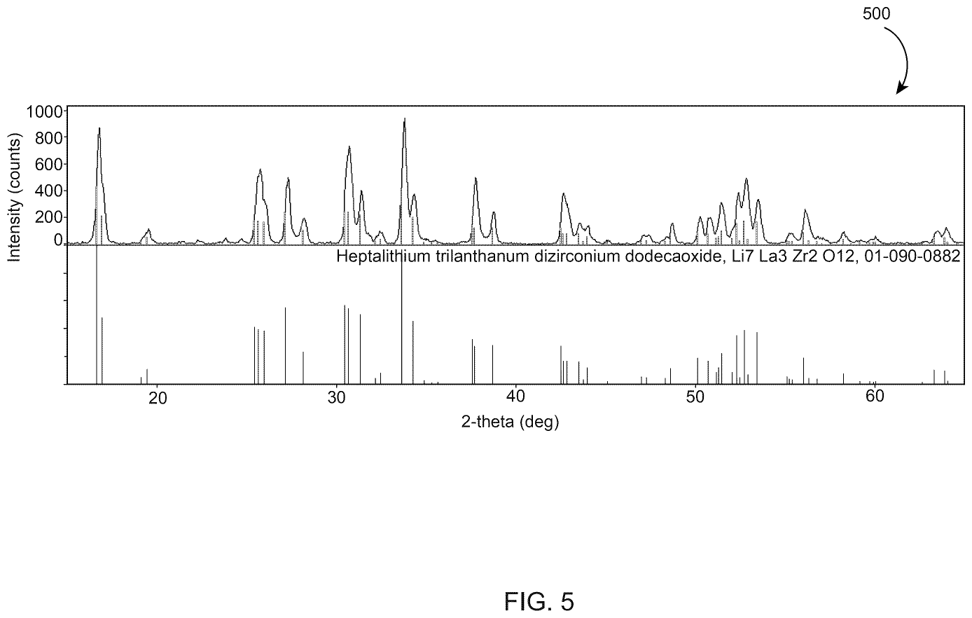

A 20 g portion of the lithiated powder was loaded into a corundum (Al₂O₃) combustion boat and calcined in an electric kiln for 8 hours at 1050° C. to form a comparative powder having tetragonal phase LLZO. The resultant powder, which was also white in color, was analyzed by powder x-ray diffraction (as above) and found to include tetragonal phase LLZO as the major phase as well as minor phases: LiAlO₂, Li₂ZrO₃, and LaAlO₃. The x-ray diffraction pattern for CE1 is shown in FIG. 5.

Due to the overlap of tetragonal and cubic peaks, accurate refinement results were not possible to quantitatively determine if any cubic LLZO phase content was present.

In comparing the x-ray diffraction pattern of CE1 with that of Ex. 1, it was observed that lithiating the oxide powder in the presence of water and then heating to dry the mixture at low pressure to form a dried lithiated powder advantageously produced high purity cubic garnet LLZO upon calcinations, whereas the CE1 (omitting the water and drying) did not.

Alternative salts for lithiation were tested and are discussed below.

### Example 2 (Ex. 2): Lithiation (LiNO₃) (Low MP Salt) with Low Pressure Drying

Cubic garnet LLZO of Ex. 2 was synthesized as follows. The dried oxide powder (precursor blend as above) was lithiated with lithium salt LiNO₃ (low melting point of 255° C.) as follows. 50.0 g of the dried powder along with 34.5 g of LiNO₃ (lithium salt) were loaded into a 1 L stainless steel reactor. 150 ml of deionized water was added to the dried oxide powder/LiNO₃ blend to form a mixture. The mixture was stirred rapidly for 5 minutes.

As in Ex. 1, the reactor was then heated to 110° C. at low pressure (vacuum) of 91.4 kPa (27″ Hg) for 12 hours to remove the water from the mixture, thus forming a dried lithiated powder. The dried lithiated powder was removed from the reactor and ground to a −40 mesh powder. A 20 g portion of the lithiated powder was loaded into a corundum (Al₂O₃) combustion boat and calcined in an electric kiln for 8 hours at 1050° C. to form the lithium lanthanum zirconium oxide powder of high cubic garnet phase purity.

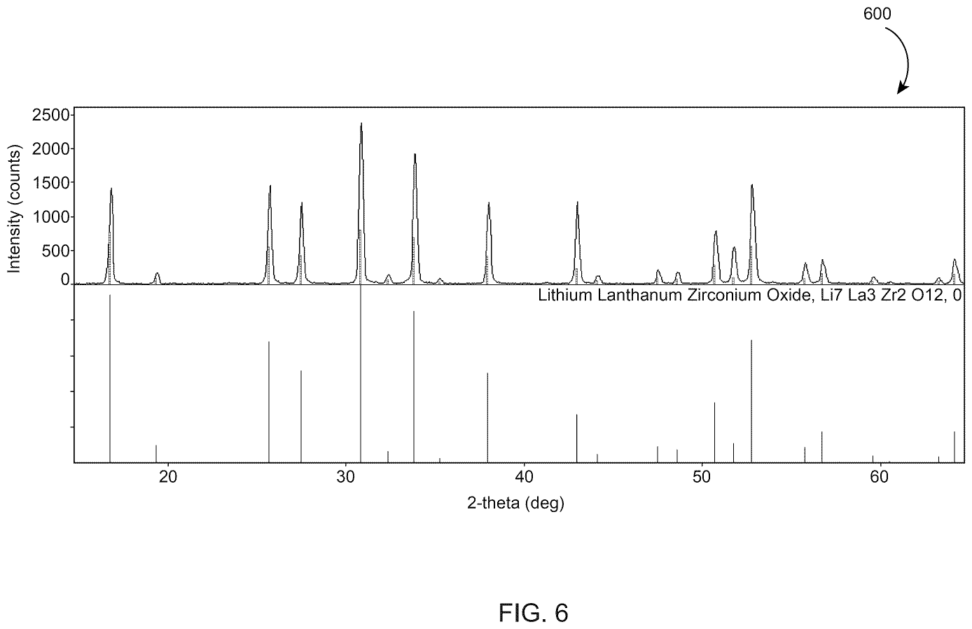

The resultant powder was analyzed by powder x-ray diffraction as above. Rietveld refinement of the data found the material to be 95 wt % cubic LLZO phase with trace impurity phases LiAlO₂ and LaAlO₃ totaling 5 wt %. The x-ray diffraction pattern for Ex. 2 is shown in FIG. 6.

### Comparative Example 2 (CE2): Lithiation (LiCl) (High MP Salt) with Low Pressure Drying and High MP Lithium Salt

The dried oxide powder (precursor blend as above) was lithiated with LiCl (high melting point of 605° C.) as follows. CE2 was prepared by weighing 50.0 g of the dried powder along with 21.2 g of LiCl and were loaded into a 1 L stainless steel reactor. 150 ml of deionized water was added to the dried oxide powder/LiCl blend to form a mixture. The mixture was stirred rapidly for 5 minutes.

As in Examples 1 and 2, the reactor was then heated to 110° C. with a vacuum of 91.4 kPa (27″ Hg) for 12 hours to remove the water from the mixture. The dried solids were removed from the reactor and ground to a −40 mesh powder. A 20 g portion of the lithiated powder was loaded into a corundum (Al₂O₃) combustion boat and calcined in an electric kiln for 8 hours at 1050° C.

The resultant powder was analyzed by powder x-ray diffraction as above. Rietveld refinement of the data found the CE2 material to contain 85 wt % La₂Zr₂O₇ pyrochlore phase, 12 wt % La₂O₃, and 2 wt % LaAlO₃. No cubic or tetragonal garnet phases were observed. It was observed that the desired cubic garnet LLZO could not be attained lithiating using LiCl as the lithium salt.

### Comparative Example 3 (CE3): Lithiation (LiCH₃CO₂) with Low Pressure Drying

The dried oxide powder (precursor blend as above) was lithiated with LiCH₃CO₂ as follows. CE3 was prepared by weighing 50.0 g of the dried powder along with 33.0 g of lithium acetate (LiCH₃CO₂) and were loaded into a 1 L stainless steel reactor. 150 ml of deionized water was added to the dried oxide powder/LiCH₃CO₂ blend to form a mixture. The mixture was stirred rapidly for 5 minutes.

As above, the reactor was then heated to 110° C. with a vacuum of 91.4 kPa (27″ Hg) for 12 hours to remove the water from the mixture. The dried solids were removed from the reactor and ground to a −40 mesh powder. A 20 g portion of the lithiated powder was loaded into a corundum (Al₂O₃) combustion boat and calcined in an electric kiln for 8 hours at 1050° C.

The resultant powder was analyzed by powder x-ray diffraction as above. Rietveld refinement of the data found the CE3 material to contain 17 wt % cubic LLZO phase, 81 wt % La₂Zr₂O₇ pyrochlore phase, and 2 wt % LaAlO₃. While some cubic garnet LLZO was present as a minor phase, it was observed that the desired high purity of cubic garnet LLZO could not be attained lithiating using lithium acetate as the lithium salt by the process as in inventive Examples 1 and 2.

### Comparative Example 4 (CE4): Lithiation (LiCH₃CO₂) with Filtration

The dried oxide powder (precursor blend as above) was lithiated with LiCH₃CO₂ as follows. CE4 was prepared by weighing 50.0 g of the dried powder along with 21.2 g of lithium acetate (LiCH₃CO₂) and were loaded into a 1 L stainless steel reactor. 150 ml of deionized water was added to the dried oxide powder/LiCH₃CO₂ blend to form a mixture. The mixture was stirred rapidly for 5 minutes.

A saturated solution of Na₂CO₃ was slowly added to the mixture until a pH of 12 was reached. Na₂CO₃, which is also water soluble, was added to the lithiated mixture to precipitate out any insoluble Li₂CO₃ in the mixture leaving behind sodium acetate in solution. The solids were then filtered, washed with 300 ml of deionized water and allowed to dry in air overnight. By adding the Na₂CO₃ the low pressure drying was omitted as the reaction to precipitate Li₂CO₃ generated Na Acetate as a soluble by-product that needed to be removed via filtration. The resulting powdered solids were ground to −40 mesh powder. A 20 g portion of the lithiated powder was loaded into a corundum (Al₂O₃) combustion boat and calcined in an electric kiln for 8 hours at 1050° C.

The resultant powder was analyzed by powder x-ray diffraction as above. Rietveld refinement of the data found the CE4 material to contain 74 wt % La₂Zr₂O₇ pyrochlore phase, 13 wt % La₂O₃, 10 wt % LaAlO₃, and 3 wt % LiAlLa₂O₇. No cubic or tetragonal garnet phases were observed. It was observed again that the desired cubic garnet LLZO could not be attained lithiating using lithium acetate as the lithium salt.

### Comparative Example 5 (CE5): Lithiation (Li₂SO₄) (High MP Salt) with Low Pressure Drying

The dried oxide powder (precursor blend as above) was lithiated with Li₂SO₄ (high melting point of 859° C.) as follows. CE5 was prepared by weighing 50.0 g of the dried powder along with 27.5 g of Li₂SO₄ and were loaded into a 1 L stainless steel reactor. 150 ml of deionized water was added to the dried oxide powder/Li₂SO₄ blend to form a mixture. The mixture was stirred rapidly for 5 minutes.

As above, the reactor was then heated to 110° C. with a vacuum of 91.4 kPa (27″ Hg) for 12 hours to remove the water from the mixture. The dried solids were removed from the reactor and ground to a −40 mesh powder. A 20 g portion of the lithiated powder was loaded into a corundum (Al₂O₃) combustion boat and calcined in an electric kiln for 8 hours at 1050° C.

The resultant powder was analyzed by powder x-ray diffraction as above. Rietveld refinement of the data found the CE5 material to contain 88 wt % La₂Zr₂O₇ pyrochlore phase, 8 wt % La₂O₃, and 4 wt % Li₂SO₄. No cubic or tetragonal garnet phases were observed. It was observed that the desired cubic garnet LLZO could not be attained lithiating using lithium sulfate as the lithium salt.

TABLE 1
Alternative Salt for Lithiation Melting
Point and Resultant Cubic Phase Present

| | | |
|---|---|---|
| Li Salt | Melting Point (° C.) | Cubic Garnet phase (wt %) |

Examples

| | | |
|---|---|---|
| Ex. 1 LiOH | 462 | 97 |
| Ex. 2 LiNO₃ | 253 | 95 |

Comparative Examples

| | | |
|---|---|---|
| CE2 LiCl | 605 | 0 |
| CE3 LiCH₃CO₂ | 286 | 17 |
| CE4 LiCH₃CO₂ | 286 | 0 |
| CE5 Li₂SO₄ | 859 | 0 |

Surprisingly, only certain lithium salts of those tested for lithiating the precursor blend yielded acceptable cubic garnet phase purity after calcination, namely LiOH and LiNO₃, as shown in Table 1 having greater than 97% and 95% cubic garnet LLZO phase, respectively. Phase purity predictability using alternative Li salts is believed to be dependent upon the ready availability of free Li+ at low temperatures, e.g., temperatures at or below 500° C. LiOH and LiNO₃, which work well, melt and dissociate Li+ from their respective anions easily. Whereas, LiCH₃CO₂ works to a lesser degree (yielding 17% cubic LLZO phase) due to its low melting point but the acetate ligand, which has a different form, does not dissociate from Li+ as readily. The remaining salts, LiCl and Li₂SO₄, have a melting point that is too high (e.g., greater than 500° C.) to achieve the desired high cubic garnet phase purity.

The findings were unexpected because initially it was believed that any water soluble lithium salt that begins to melt and decompose below reaction temperatures, e.g., calcining from about 900° C. to 1100° C. would work. However, without being bound by theory, it is believed that intermediate La₂Zr₂O₇ phases react with Li (and with dopants such as Al) at an intermediate temperature range of about 400° C. to 550° C. Thus, lithiating with salts that have higher melting temperatures do not provide enough Li availability to support reactions required to produce LLZO powders having the desired high cubic garnet phase purity.

### EMBODIMENTS

The following embodiments are contemplated. All combinations of features and embodiments are contemplated.

Embodiment 1. A process of synthesizing a lithium lanthanum zirconium oxide powder, the process comprising: mixing a lithium salt, water, and a precursor blend comprising a lanthanum precursor and a zirconium precursor to form a mixture; heating the mixture at low pressure to form a dried lithiated powder; and calcining the dried lithiated powder to form the lithium lanthanum zirconium oxide powder; wherein the lithium salt has a melting point of less than 605° C.; and wherein the lithium salt does not comprise lithium acetate.

Embodiment 2. The process of embodiment 1, wherein the lithium salt comprises a soluble lithium salt selected from: lithium citrate, lithium hydroxide, lithium nitrate, or hydrates thereof, or combinations thereof.

Embodiment 3. The process of either of embodiments 1-2, wherein the lithium salt comprises lithium hydroxide or lithium nitrate, or hydrates thereof, or combinations thereof.

Embodiment 4. The process of any of embodiments 1-3, wherein heating the mixture at low pressure includes heating to a temperature from 85° C. to 135° C. at a pressure of from 51 kPa to 101 kPa.

Embodiment 5. The process of any of embodiments 1-4, wherein heating the mixture includes heating to a temperature from 85° C. to 135° C., with a vacuum of greater than 91.4 kPa, for a time of from 8 hours to 16 hour to remove the water from the mixture to form the dried lithiated powder.

Embodiment 6. The process of any of embodiments 1-5, wherein calcining the dried lithiated powder includes calcining to a temperature from 900° C. to 1100° C. for a time of from 4 hours to 12 hour to form the lithium lanthanum zirconium oxide powder.

Embodiment 7. The process of any of embodiments 1-6, wherein the lanthanum precursor comprises lanthanum hydroxide or lanthanum oxide or a combination thereof and the zirconium precursor comprises zirconium oxide or zirconium hydroxide or a combination thereof.

Embodiment 8. The process of any of embodiments 1-7, wherein the precursor blend further comprises a dopant selected from an aluminum precursor, a tantalum precursor, a niobium precursor, a gallium precursor, or an indium precursor, or combinations thereof.

Embodiment 9. The process of any of embodiments 1-8, wherein the precursor blend comprises lanthanum oxide and zirconium oxide; or lanthanum oxide, zirconium oxide, and aluminum oxide.

Embodiment 10. The process of any of embodiments 1-9, further comprising milling the lanthanum precursor and the zirconium precursor and water to form a slurry and drying the slurry to form the precursor blend before mixing with the lithium salt.

Embodiment 11. The process of any of embodiments 1-10, wherein the precursor blend comprises particles having a d₉₀ of less than 10 microns or an average particle size of less than 5 microns.

Embodiment 12. The process of any of embodiments 1-11, wherein the mixture comprises from 55 wt % to 75 wt % lanthanum oxide and from 25 wt % to 40 wt % zirconium oxide, based upon total weight of the mixture.

Embodiment 13. The process of any of embodiments 1-12, wherein the mixture further comprises from 0.5 wt % to 5 wt % of aluminum oxide, tantalum oxide, or niobium oxide, or combinations thereof based upon total weight of the mixture.

Embodiment 14. The process of any of embodiments 1-13, wherein the mixture comprises from 15 wt % to 35 wt % of lithium hydroxide and/or lithium hydroxide monohydrate, based upon total weight of the mixture.

Embodiment 15. A lithium lanthanum zirconium oxide powder formed by the process of any of embodiments 1-14, the lithium lanthanum zirconium oxide powder having a cubic garnet phase purity of greater than 95 wt %.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/components/steps and permit the presence of other ingredients/components/steps. However, such description should be construed as also describing compositions, articles, or processes as “consisting of” and “consisting essentially of” the enumerated ingredients/components/steps, which allows the presence of only the named ingredients/components/steps, along with any impurities that might result therefrom, and excludes other ingredients/components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams or 10 grams, and all the intermediate values).

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

When a material is described as having an average particle size or average particle size distribution, which is defined as the particle diameter at which a cumulative percentage of 50% (by volume) of the total number of particles are attained. In other words, 50% of the particles have a diameter above the average particle size, and 50% of the particles have a diameter below the average particle size. The size distribution of the particles will be Gaussian, with upper and lower quartiles at 25% and 75% of the stated average particle size, and all particles being less than 150% of the stated average particle size.

The process steps described herein refer to temperatures, and, unless provided for, this refers to the temperature attained by the material that is referenced, rather than the temperature at which the heat source (e.g., furnace, oven) is set. The term “room temperature” refers to a range of from 20° C. to 25° C. (68° F. to 77° F.).

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about” may refer to plus or minus 10% of the indicated number.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

1. A process of synthesizing a lithium lanthanum zirconium oxide powder, the process comprising:
mixing a lithium salt, water, and a precursor blend comprising a lanthanum precursor and a zirconium precursor to form a mixture;
heating the mixture at low pressure to form a dried lithiated powder; and
calcining the dried lithiated powder to form the lithium lanthanum zirconium oxide powder;
wherein the lithium salt has a melting point of less than 605° C.; and
wherein the lithium salt does not comprise lithium acetate.

2. The process of claim 1, wherein the lithium salt comprises a soluble lithium salt selected from: lithium citrate, lithium hydroxide, lithium nitrate, or hydrates thereof, or combinations thereof.

3. The process of claim 1, wherein the lithium salt comprises lithium hydroxide or lithium nitrate, or hydrates thereof, or combinations thereof.

4. The process of claim 1, wherein heating the mixture at low pressure includes heating to a temperature from 85° C. to 135° C. at a pressure of from 51 kPa to 101 kPa.

5. The process of claim 1, wherein heating the mixture includes heating to a temperature from 85° C. to 135° C., with a vacuum of greater than 91.4 kPa, for a time of from 8 hours to 16 hour to remove the water from the mixture to form the dried lithiated powder.

6. The process of claim 1, wherein calcining the dried lithiated powder includes calcining to a temperature from 900° C. to 1100° C. for a time of from 4 hours to 12 hour to form the lithium lanthanum zirconium oxide powder.

7. The process of claim 1, wherein the lanthanum precursor comprises lanthanum hydroxide or lanthanum oxide or a combination thereof and the zirconium precursor comprises zirconium oxide or zirconium hydroxide or a combination thereof.

8. The process of claim 1, wherein the precursor blend further comprises a dopant selected from an aluminum precursor, a tantalum precursor, a niobium precursor, a gallium precursor, or an indium precursor, or combinations thereof.

9. The process of claim 1, wherein the precursor blend comprises lanthanum oxide and zirconium oxide; or lanthanum oxide, zirconium oxide, and aluminum oxide.

10. The process of claim 1, further comprising milling the lanthanum precursor and the zirconium precursor and water to form a slurry and drying the slurry to form the precursor blend before mixing with the lithium salt.

11. The process of claim 10, wherein the precursor blend comprises particles having a d₉₀ of less than 10 microns or an average particle size of less than 5 microns.

12. The process of claim 1, wherein the mixture comprises from 55 wt % to 75 wt % lanthanum oxide and from 25 wt % to 40 wt % zirconium oxide, based upon total weight of the mixture.

13. The process of claim 12, wherein the mixture further comprises from 0.5 wt % to 5 wt % of aluminum oxide, tantalum oxide, or niobium oxide, or combinations thereof based upon total weight of the mixture.

14. The process of claim 1, wherein the mixture comprises from 15 wt % to 35 wt % of lithium hydroxide and/or lithium hydroxide monohydrate, based upon total weight of the mixture.

15. A lithium lanthanum zirconium oxide powder formed by the process of claim 1, the lithium lanthanum zirconium oxide powder having a cubic garnet phase purity of greater than 95 wt %.
